(19) United States
(12) Patent Application Publication
(10) Pub. No.: US 2026/0358037 A1
(43) Pub. Date: Nov. 12, 2026

(54) REFRIGERATOR

(71) Applicant: LG Electronics Inc., Seoul (KR)

(72) Inventor: Daeun KIM, Seoul (KR)

(21) Appl. No.: 19/644,851

(22) Filed: Apr. 10, 2026

(30) Foreign Application Priority Data
May 12, 2025 (KR) 10-2025-0061129

(51) Int. Cl. F25D 23/02; E05D 5/02; E05D 5/12; E05D 5/10

(52) U.S. Cl. CPC F25D 23/028; E05D 5/0276; E05D 5/121; E05D 2005/102; E05Y 2900/31; F25D 2323/024

(57) ABSTRACT

A refrigerator includes a cabinet forming a storage space, a door configured to open and close the storage space, a hinge including a hinge plate mounted to the cabinet and a first hinge pin and a second hinge pin protruding from the hinge plate and connected to a hinge mounting portion recessed in the door, and a guide groove provided in the hinge mounting portion, into which both the first hinge pin and the second hinge pin are inserted and which guides movement of the first hinge pin and the second hinge pin during rotation of the door. The hinge mounting portion is provided at each of left and right sides of an upper surface of the door, and the hinge is selectively mounted to one of the hinge mounting portions on the left and right sides according to an opening and closing direction of the door.

### CROSS-REFERENCE TO RELATED APPLICATIONS

The present application claims priority under 35 U.S.C. 119 and 35 U.S.C. 365 to Korean Patent Application No. 10-2025-0061129, filed on May 12, 2025, which is hereby incorporated by reference in its entirety.

### BACKGROUND

The present disclosure relates to a refrigerator.

In general, a refrigerator is a home appliance configured to store food at a low temperature in an internal storage space shielded by a door. For this purpose, the refrigerator is configured to cool the interior of the storage space by using cold air generated through heat exchange with a refrigerant circulating in a refrigeration cycle, thereby allowing stored food to be preserved in an optimal condition.

In recent years, refrigerators have tended to become larger and more multifunctional in response to changes in dietary habits and trends toward product premiumization, and various refrigerator structures considering user convenience have been introduced.

In particular, recent refrigerators are designed to be embedded in a wall or arranged to harmonize with other furniture or home appliances. In this case, the refrigerator requires a predetermined separation distance in order to prevent interference between an edge portion of a rotating door and an adjacent wall, piece of furniture, or home appliance.

To this end, refrigerators have been developed in which a door is supported by a plurality of hinge pins and is opened and closed while a rotation center of the refrigerator door is changed.

However, in such refrigerators, due to a structure in which a plurality of hinge pins are arranged, hinge structures on left and right sides are inevitably configured differently from each other. Accordingly, there is a problem in that the left and right hinges must be manufactured and assembled independently.

In particular, in a refrigerator door in which a door opening direction is changeable, both left and right hinges must be provided in order to change the door opening direction, resulting in problems related to loss and management of the hinges.

### SUMMARY

An object of the present invention is to provide a refrigerator in which hinges having an identical structure are applicable to both left and right sides of a door.

Another object of the present invention is to provide a refrigerator in which a single hinge can be selectively used on either one of both sides of a door, thereby allowing a door opening direction to be changed.

An object of the present invention is to provide a refrigerator in which a hinge plate having a plurality of hinge pins can be commonly used for doors on both left and right sides.

An embodiment of the present invention is directed to providing a refrigerator including a cabinet forming a storage space, a door configured to open and close the storage space, a hinge including a hinge plate mounted to the cabinet and a first hinge pin and a second hinge pin protruding from the hinge plate and connected to a hinge mounting portion recessed in the door, and a guide groove provided in the hinge mounting portion, into which both the first hinge pin and the second hinge pin are inserted and which guides movement of the first hinge pin and the second hinge pin during rotation of the door. The hinge mounting portion is provided at each of left and right sides of an upper surface of the door, and the hinge may be mounted to one of the hinge mounting portions on the left and right sides according to an opening and closing direction of the door.

The hinge plate has planar upper and lower surfaces, and when mounted to a hinge mounting portion on one of the left and right sides, the hinge plate may be mounted in an inverted state in an upward and downward direction relative to a hinge plate mounted to the other hinge mounting portion.

The first hinge pin and the second hinge pin may be detachably mounted to the hinge plate.

The hinge plate may be formed with a pair of pin holes into which the first hinge pin and the second hinge pin are inserted, and the first hinge pin and the second hinge pin may be threadedly coupled to the pin holes.

Each of the first hinge pin and the second hinge pin may include a coupling portion having threads formed on an outer surface thereof and coupled to the pin hole, an insertion portion extending downward from the hinge plate and inserted into the guide groove, and a protruding portion protruding outward between the coupling portion and the insertion portion and contacting a lower surface of the hinge plate.

A lower end of the insertion portion may be formed in a polygonal shape, and an operation portion configured to rotate the first hinge pin or the second hinge pin so that the coupling portion and the pin hole are threadedly coupled to each other may be formed at the lower end.

The hinge plate may include a mounting portion fixed by being coupled to hinge coupling portions provided at left and right sides of an upper surface of the cabinet, and an extension portion extending forward from a front end of the mounting portion and having the first hinge pin and the second hinge pin coupled to an extended end thereof.

An inner surface of the extension portion may open toward a center of an upper end of the door and may form a recessed curved portion having a predetermined curvature.

The hinge coupling portions may include a plurality of guide protrusions protruding upward from the upper surface of the cabinet, and the mounting portion may be formed with guide holes through which the guide protrusions are inserted at positions corresponding to the guide protrusions. The guide holes may be disposed on left and right sides with respect to an extension line passing through a center of the mounting portion in a left–right direction.

The guide holes may be spaced apart from each other in a front–rear direction.

A pair of sub guide protrusions protruding upward between the plurality of guide protrusions may be formed on the hinge coupling portions, a center opening penetrating the mounting portion may be formed in the mounting portion, and the pair of sub guide protrusions may contact an inner surface of the center opening to guide mounting of the hinge.

A plurality of hinge fastening holes through which fastening members pass may be formed in the mounting portion on left and right sides with respect to the extension line passing through the center of the mounting portion in the left–right direction, and cabinet fastening holes to which the fastening members are fastened may be formed in the hinge coupling portions corresponding to the hinge fastening holes.

The cabinet fastening holes may be spaced apart from each other in a front–rear direction.

The refrigerator may further include an upper cap forming an upper surface of the door, and the hinge mounting portion may be recessed at each of left and right ends of the upper cap.

The hinge may be coupled to one of the hinge mounting portions on the left and right sides, and a mounting portion cover configured to cover the hinge mounting portion may be provided on the other hinge mounting portion.

Guide members each having the guide groove formed therein may be provided at both hinge mounting portions, and the guide members may be formed symmetrically with respect to a center of the door.

The refrigerator may further include a contact member formed in a plate shape and having a pair of through-holes through which the first hinge pin and the second hinge pin pass, wherein the guide groove and an upper end of the guide member are exposed through an upper surface of the hinge mounting portion, and the contact member may contact the upper end of the guide member.

The contact member may be formed to have a width greater than a width of the guide member.

An upper surface of the hinge coupling portion may protrude upward by a predetermined height relative to a bottom surface of the hinge mounting portion, and the contact member may be disposed between an upper surface of the guide member and a lower surface of the hinge plate.

The guide groove may be formed by continuously connecting a plurality of paths extending in different directions, and during opening and closing of the door, the first hinge pin and the second hinge pin may move along different paths among the plurality of paths.

The details of one or more embodiments are set forth in the accompanying drawings and the description below. Other features will be apparent from the description and drawings, and from the claims.

### BRIEF DESCRIPTION OF THE DRAWINGS

FIG. 1 is a front view of a refrigerator according to a first embodiment of the present invention.

FIG. 2 is a front view of the refrigerator in which a door is opened.

FIG. 3 is an exploded perspective view of the refrigerator in which an upper cover is separated.

FIG. 4 is a partial top view of the refrigerator.

FIG. 5 is a partial perspective view illustrating an assembled state of the hinge.

FIG. 6 is a side view illustrating the assembled state of the hinge.

FIG. 7 is an exploded perspective view illustrating a coupling structure of the hinge, a guide member, and the door.

FIG. 8 is a plan view illustrating an arrangement of paths forming a guide groove of the guide member.

FIG. 9 is a perspective view of the hinge.

FIG. 10 is an exploded perspective view of the hinge as viewed from above.

FIG. 11 is an exploded perspective view of the hinge as viewed from below.

FIG. 12 is a view illustrating a convertible use state of the hinge.

FIG. 13 is a view illustrating states of the hinge and the door when the door is closed.

FIG. 14 is a view illustrating states of the hinge and the door when the door is opened at a first predetermined angle.

FIG. 15 is a view illustrating states of the hinge and the door when the door is opened at a second predetermined angle.

FIG. 16 is a view illustrating states of the hinge and the door when the door is opened at a third predetermined angle.

FIG. 17 is a view illustrating states of the hinge and the door when the door is fully opened.

FIG. 18 is a partial perspective view illustrating a hinge arrangement in a state in which an opening and closing direction of the door is changed.

FIG. 19 is a partial perspective view illustrating a hinge arrangement of a refrigerator according to a second embodiment of the present invention.

### DETAILED DESCRIPTION

Hereinafter, specific embodiments of the present invention will be described in detail with reference to the drawings. However, the present invention is not limited to the embodiments in which the spirit of the present invention is disclosed, and other embodiments falling within the scope of the present invention or other inventive concepts may be readily proposed through addition, modification, or deletion of components.

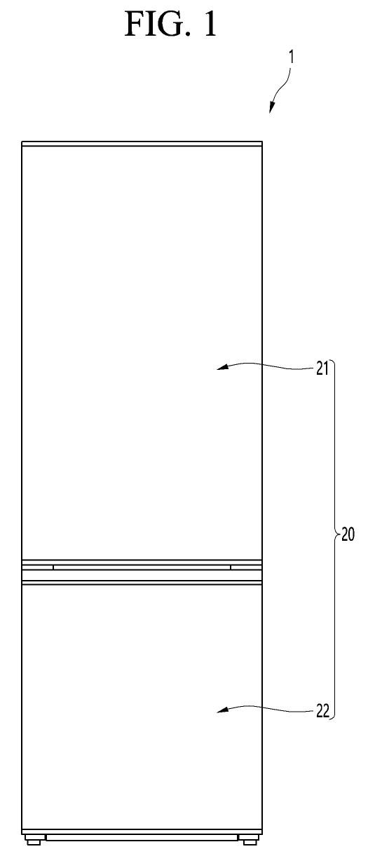

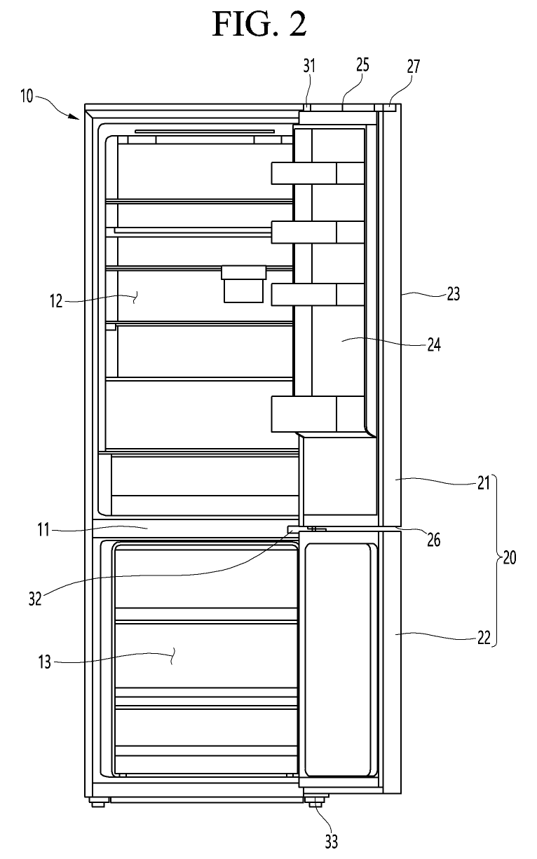

Prior to the description, directions will be defined. In the embodiments of the present invention, as shown in FIGS. 1 and 2, a direction in which a front surface of a door faces is defined as a front direction, a direction toward a cabinet with respect to the front surface of the door is defined as a rear direction, a direction toward a floor surface on which the refrigerator is installed is defined as a downward direction, and a direction away from the floor surface is defined as an upward direction. When referring to directions that are not defined above, directions may be defined and described based on each drawing.

Further, although the embodiments of the present invention are described by way of example with respect to a refrigerator in which a refrigerating compartment and a freezing compartment are arranged vertically and respective doors are provided, the present invention is not limited to a specific structure or shape of a refrigerator and is applicable to all types of refrigerators having a rotatable door.

FIG. 1 is a front view of a refrigerator according to a first embodiment of the present invention, and FIG. 2 is a front view of the refrigerator in which a door is opened.

As illustrated, a refrigerator 1 according to an embodiment of the present invention may have an overall appearance defined by a cabinet 10 forming a storage space opened at a front side, and a door 20 configured to open and close the storage space.

Further, the refrigerator 1 may be installed to harmonize with furniture or a wall in an indoor space. For example, a space corresponding to a size of the refrigerator 1 may be provided in the furniture or the wall so that the refrigerator 1 is accommodated therein, or the refrigerator 1 may be arranged as a built-in type. In addition, the refrigerator 1 may be installed such that a plurality of refrigerators is continuously arranged in parallel.

In such an arrangement structure of the refrigerator 1, a front surface of the refrigerator 1, that is, a front surface of the door 20, may be located very close to the furniture or the wall, and may be positioned on the same or a substantially adjacent plane so as to provide an integrated appearance.

Referring to the structure of the refrigerator 1 in more detail, the cabinet 10 may have the storage space partitioned in an upward and downward direction by a barrier 11 to form an upper storage space 12 and a lower storage space 13. For example, the upper storage space 12 may be a refrigerating compartment, and the lower storage space 13 may be a freezing compartment.

The door 20 may be configured to open and close the storage space, and may include an upper door 21 configured to open and close the upper storage space 12 and a lower door 22 configured to open and close the lower storage space 13.

The door 20 may include a front panel 23 forming a front surface, a door liner 24 forming a rear surface, an upper cap 25 forming an upper surface, and a lower cap 26 forming a lower surface. Further, in a state in which the front panel 23, the door liner 24, the upper cap 25, and the lower cap 26 are coupled to each other, insulation material may be filled in an interior of the door 20. In addition, the door 20 may further include side frames forming left and right side surfaces.

The upper door 21 and the lower door 22 may be rotatably mounted by being connected to the cabinet 10 by hinges 31, 32, and 33. Further, the upper storage space 12 and the lower storage space 13 may be opened and closed by rotation of the upper door 21 and the lower door 22.

The door 20 may be connected to the cabinet 10 by the hinges 31, 32, and 33 so as to be rotatable. For example, a first hinge 31 and a second hinge 32 may be provided at an upper end and a lower end of the upper door 21 to support the upper door 21 from an upward side and a downward side. Further, the second hinge 32 and a third hinge 33 may be provided at an upper end and a lower end of the lower door 22 to support the lower door 22 from the upward side and the downward side. The second hinge 32 may support a lower end of the upper door 21 and an upper end of the lower door 22.

The first hinge 31 may be referred to as an upper hinge, the second hinge 32 may be referred to as a center hinge, and the third hinge 33 may be referred to as a lower hinge.

Meanwhile, the hinges 31, 32, and 33 may be provided at one of left and right side ends of the door 20, such that the door 20 is allowed to rotate in one direction. Further, the door 20 may change an opening and closing direction, that is, a rotation direction, depending on an installation environment of the refrigerator 1 or a user’s preference. To this end, the hinges 31, 32, and 33 may be provided at the other one of the left and right side ends of the door 20.

Hereinafter, among the hinges, the first hinge 31 will be described. For convenience of description and understanding, the first hinge 31 may be referred to as a hinge 31, and the upper door 21 may be referred to as a door 21.

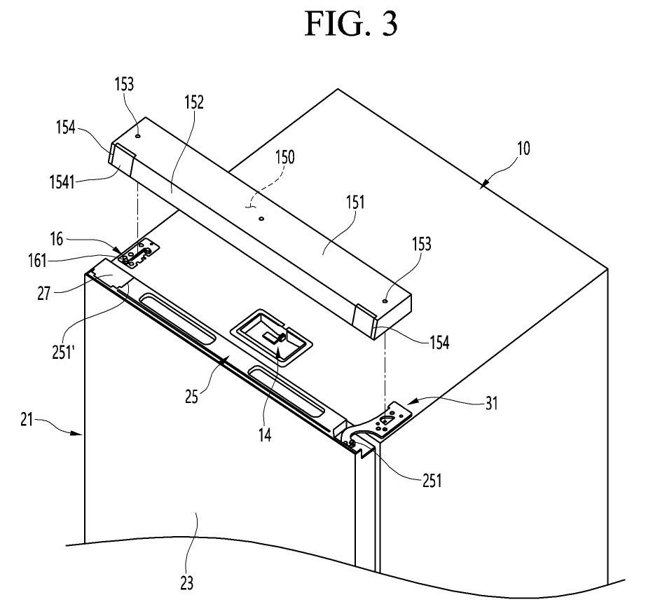

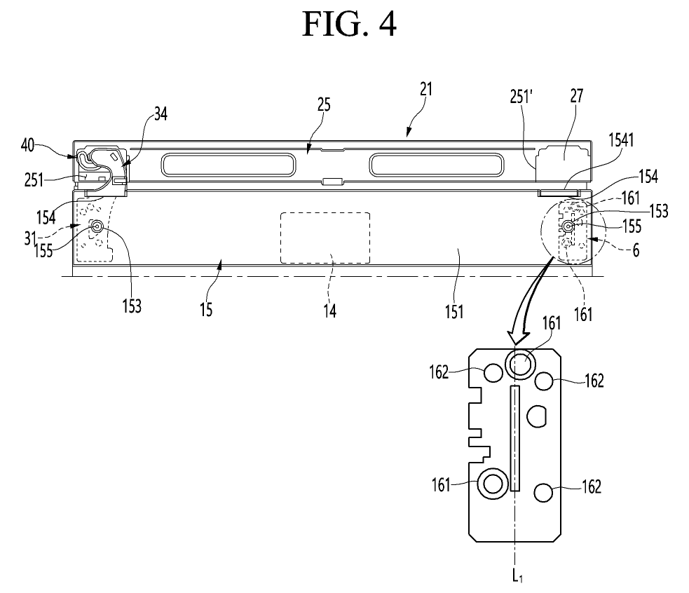

FIG. 3 is an exploded perspective view of the refrigerator in which an upper cover is separated, and FIG. 4 is a partial top view of the refrigerator.

As illustrated, a hinge coupling portion 16 to which the hinge 31 is fixed may be formed on an upper surface of the cabinet 10. The hinge coupling portion 16 may be positioned at a location corresponding to a position of the hinge 31. Further, the hinge coupling portion 16 may be located adjacent to a front end of the upper surface of the cabinet 10. In addition, the hinge coupling portions 16 may be formed on both left and right sides of the upper surface of the cabinet 10. Accordingly, depending on an opening and closing direction of the door 21, the hinge 31 may be fixedly mounted to the hinge coupling portion 16 on one of the left and right sides.

Further, the hinge coupling portion 16 may include guide protrusions 161 for alignment of the hinge 31, and cabinet fastening holes 162 to which fastening members 319 for fixing the hinge 31 are fastened. In detail, the guide protrusions 161 may be formed at positions corresponding to guide holes 315 formed in the hinge 31. A plurality of guide protrusions 161 may be formed, and by the plurality of guide protrusions 161, the hinge 31 may be aligned at a correct position on the hinge coupling portion 16 and may be in a primary fixed state. For example, the guide protrusions 161 may be positioned on both left and right sides with respect to an extension line L1 passing through a center of the hinge coupling portion 16. In addition, the guide protrusions 161 may be spaced apart from each other in a front–rear direction.

When the guide protrusions 161 are inserted into the guide holes 315, the hinge 31 may be accurately aligned and temporarily fixed. Further, hinge fastening holes 316 formed in the hinge 31 and the cabinet fastening holes 162 may be aligned with each other, thereby facilitating fastening of the fastening members 319.

Further, a plurality of cabinet fastening holes 162 may be provided and may be formed at positions corresponding to the hinge fastening holes 316. The cabinet fastening holes 162 may be positioned on both left and right sides with respect to the extension line L1 passing through the center of the hinge coupling portion 16. In addition, the cabinet fastening holes 162 may be spaced apart from each other in the front–rear direction.

The guide protrusions 161 and the cabinet fastening holes 162 formed in each of the hinge coupling portions 16 provided on both left and right sides may have different orientations, but may be formed to be symmetrical with respect to a center of the cabinet. Accordingly, when the hinge 31 arranged on one of the hinge coupling portions 16 is inverted, the hinge 31 may be mounted to the hinge coupling portion 16 on the other side. That is, the hinge 31 has a structure mountable to both left and right hinge coupling portions 16, and may be selectively mounted on either one side. Accordingly, the hinge 31 may be selectively mounted on one of the hinge coupling portions 16 on both sides depending on an opening and closing direction of the door 21.

Further, the hinge coupling portion 16 may further include sub guide protrusions 164 that assist alignment of the hinge 31. For example, a pair of sub guide protrusions 164 may be provided and may be spaced apart from each other in a front–rear direction along the same extension line. The sub guide protrusions 164 may contact an inner surface of a center opening 314 formed in the hinge, thereby enabling additional alignment of the hinge 31.

Further, the hinge coupling portion 16 may further include cover fastening holes 163 for fixing an upper cover 15. Screws penetrating the upper cover 15 may be fastened to the cover fastening holes 163 when the upper cover 15 is mounted. The cover fastening holes 163 may be positioned inside the center opening 314.

A control unit 14 may be provided on an upper surface of the cabinet 10. The control unit 14 may be configured to control at least a part of an operation of the refrigerator 1. The control unit 14 may be positioned between the hinge coupling portions 16 on the left and right sides.

Further, an upper cover 15 may be provided on an upper portion of the cabinet 10. The upper cover 15 may shield a portion of the hinge 31. The upper cover 15 may shield both the hinge on one of the left and right sides and the hinge coupling portion 16 on the other side. For example, the upper cover 15 may be provided at a front end of the upper surface of the cabinet 10 and may be formed to have a length corresponding to a lateral width of the cabinet 10. Accordingly, by mounting the upper cover 15, the hinge 31, the hinge coupling portions 16, and the controller 14 may all be shielded.

The upper cover 15 may include a cover upper surface 151 forming an upper surface, and a cover rim 152 forming a periphery of the cover upper surface 151. Further, a lower surface of the upper cover 15 may be open so as to accommodate the hinge 31, the hinge coupling portion 16, and the control unit 14 therein.

A cover fastening hole 153 may be formed in the cover upper surface 151. The cover fastening hole 153 may be formed above a position corresponding to the cover fastening hole 163. A screw passing through the cover fastening hole 153 may be fastened to the cover fastening hole 163, such that the upper cover 15 is fixedly mounted to the upper surface of the cabinet 10.

In this case, a fastening boss 155 may be formed around the cover fastening hole 153. The fastening boss 155 may extend downward from the cover upper surface 151 and may be inserted into an inside of the center opening 314. Further, a lower end of the fastening boss 155 may support the upper surface of the cabinet 10. An inside of the fastening boss 155 may be hollow so as to form the cover fastening hole 153.

A cover opening 154 may be formed at a front side of the cover rim 152. The cover opening 154 may be formed at a position corresponding to the hinge 31. Further, at least a portion of the hinge 31 may protrude through the cover opening 154. For example, when the upper cover 15 is mounted to the cabinet 10, the upper cover 15 may shield a mounting portion 311 of the hinge 31, and an extension portion 312 of the hinge 31 may extend forward through the cover opening 154. Further, a pair of hinge pins 330 disposed at an extended end of the extension portion 312 may be inserted into a door mounting portion 251 on an upper surface of the door 21. The hinge pins 330 may include a first hinge pin 331 and a second hinge pin 332.

Further, a portion of the hinge 31 protruding forward from the upper cover 15 may be shielded by a hinge cover 34. That is, the entire hinge 31 may be shielded by the upper cover 15 and the hinge cover 34. The hinge cover 34 may shield the extension portion 312 protruding forward from the upper cover 15, and a rear end of the hinge cover 34 may be coupled to the upper cover 15.

Meanwhile, a pair of cover openings 154 may be formed on left and right sides. The cover openings 154 may be formed in front of the hinge coupling portions 16. Further, a cover cap 1541 may be provided in the cover opening 154 corresponding to one of the hinge coupling portions 16 to which the hinge 31 is not mounted. The cover cap 1541 may be formed in a shape corresponding to the cover opening 154 so as to shield the cover opening 154, and may be detachably mounted to the cover opening 154.

The cover cap 1541 may be mountable to both of the pair of cover openings 154 formed on the left and right sides of the upper cover 15. That is, the pair of cover openings 154 may have identical shapes, differing only in position. Accordingly, depending on a mounting position of the hinge 31, the cover cap 1541 may shield the cover opening 154 on the other side.

A front end of the hinge 31 may extend to a hinge mounting portion 251 recessed into an upper surface of the door 21. The hinge mounting portion 251 may be recessed in the upper cap 25. The hinge mounting portions 251 may be formed at both left and right side ends of the door 21. Further, a mounting portion cover 27 may be detachably mounted to the hinge mounting portion 251′ on which the hinge 31 is not mounted, among the hinge mounting portions 251 and 251′ on the left and right sides.

The mounting portion cover 27 may be mountable to both of the hinge mounting portions 251 formed on left and right sides of the upper surface of the door 21. In this case, the hinge mounting portions 251 on the left and right sides may be formed to have identical shapes, and the mounting portion cover 27 may shield the hinge mounting portion 251′ on which the hinge 31 is not mounted.

That is, when an opening and closing direction of the door 21 is determined and the hinge 31 is mounted on one of left and right sides of the door 21 and the cabinet 10, the cover cap 1541 and the mounting portion cover 27 may be mounted on the other one of the left and right sides of the door 21 and the cabinet 10, respectively, so as to shield the cover opening 154 and the hinge mounting portion 251, respectively.

Hereinafter, a mounted state of the hinge 31 will be described in more detail with reference to the drawings.

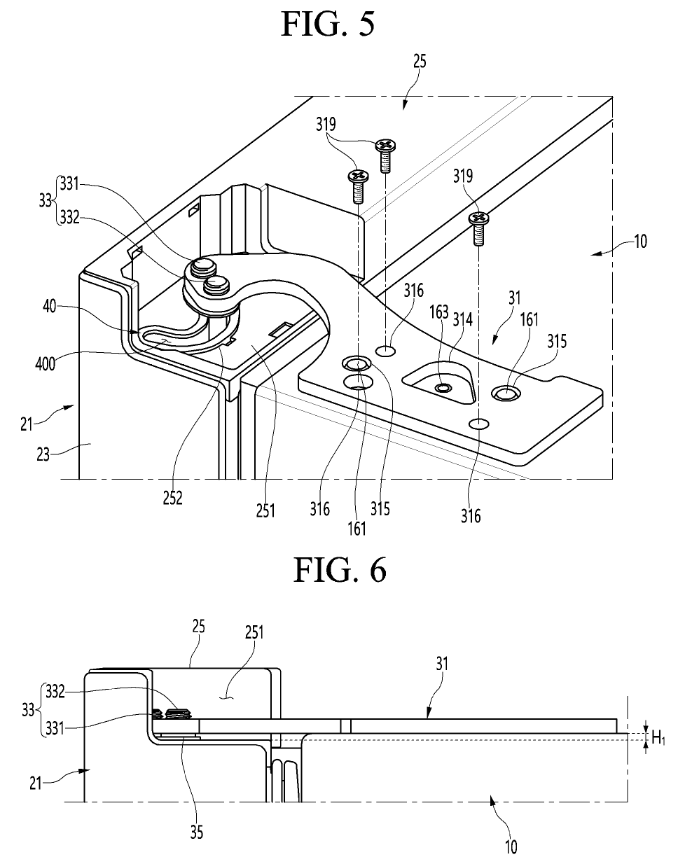

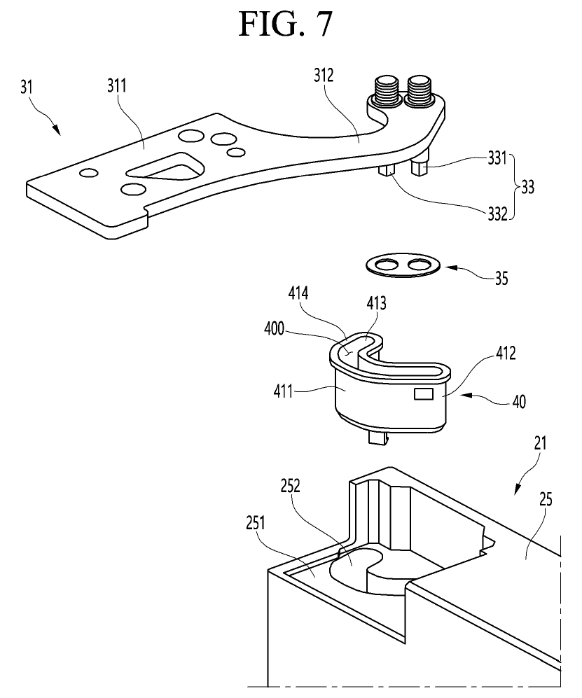

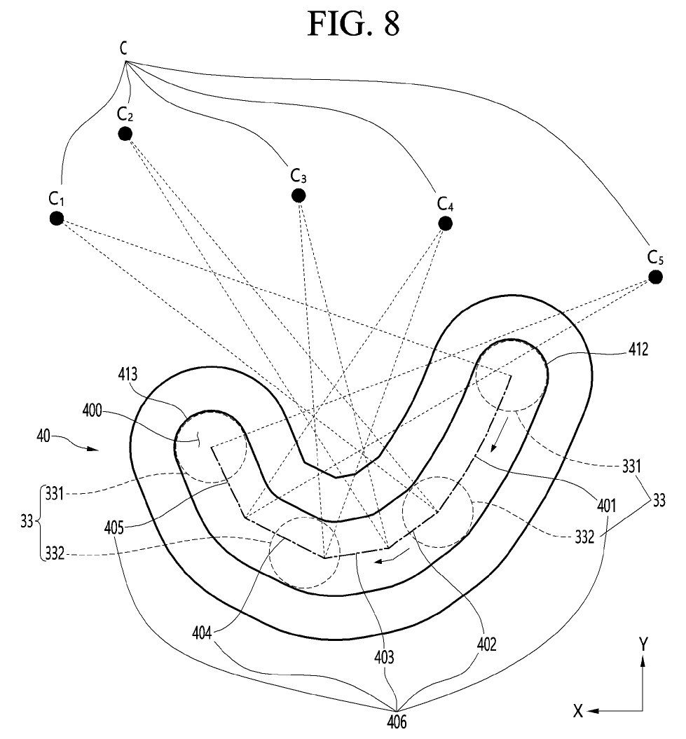

FIG. 5 is a partial perspective view illustrating an assembled state of the hinge, and FIG. 6 is a side view illustrating the assembled state of the hinge, and FIG. 7 is an exploded perspective view illustrating a coupling structure of the hinge, a guide member, and the door, and FIG. 8 is a plan view illustrating an arrangement of paths forming a guide groove of the guide member.

As illustrated, the hinge 31 may include a plate-shaped hinge plate 310 and hinge pins 330 for rotational movement of the door 21.

The hinge plate 310 may be formed of a metal material, and an upper surface and a lower surface thereof may be formed in planar shapes. Accordingly, since the hinge plate 310 is formed to have no structure bent in an upward or downward direction, a single hinge plate 310 may be selectively mounted by being inverted in an upward and downward direction depending on a mounting position on left or right sides of the door 21.

Accordingly, a height of the hinge coupling portion 16 to which the hinge plate 310 is fixedly mounted may be the same as a height of the hinge mounting portion 251 of the door 21, or may be formed to be slightly higher by a predetermined height H1.

The hinge mounting portion 251 may be recessed from an upper end of the door 21. In detail, the hinge mounting portion 251 may be formed in the upper cap 25 and may be recessed downward. The hinge mounting portion 251 may be open at an upper surface, side surfaces, and a rear surface thereof. Further, a front end of the hinge plate 310 may extend so as to be positioned above the hinge mounting portion 251.

A guide member 40 connected to the hinge pins 330 and configured to guide movement of the hinge pins 330 may be provided in the hinge mounting portion 251. Further, a mounting hole 252 into which the guide member 40 is inserted may be formed in a bottom surface of the hinge mounting portion 251. The guide member 40 may form a guide groove 400 configured to guide movement of the hinge pins 330 during opening and closing of the door 21. The guide groove 400 may be composed of a plurality of paths 406 and may be formed to minimize lateral protrusion of an edge of the door 21 when the door 21 is opened and closed.

In a state in which the guide member 40 is mounted in the hinge mounting portion 251, the guide groove 400 may be exposed downward. The hinge pins 330 may be inserted into the guide groove 400, and during an opening and closing operation of the door 20, the hinge pins 330 may move along the guide groove 400. The guide member 40 may include a pair of side portions 411 spaced apart from each other, and a first connection portion 412 and a second connection portion 413 connecting end portions of the pair of side portions 411.

Further, a rim portion 414 may be formed at an upper end of the guide member 40 at which the guide groove 400 is open. The rim portion 414 may be formed along a periphery of the guide groove 400. The rim portion 414 may protrude outward from a lower end of the guide member 40. That is, the rim portion 414 may be formed to be thicker than a thickness of the side portions 411 of the guide member 40. Accordingly, an upper end of the guide member 40 may be reinforced by the rim portion 414 and may not be damaged even when contacting the hinge pins 330 and contact members 35.

Further, when the guide member 40 is mounted to the upper cap 25, the rim portion 414 may be exposed toward the bottom surface of the hinge mounting portion 251. The rim portion 414 may contact the contact members 35 mounted on the hinge pins 330.

The guide member 40 may be provided on a lower surface of the door 20 in the same structure, except for a difference in a mounting direction. Further, the guide member 40 may be integrally formed with the upper cap 25, and the guide groove 400 may be formed to be recessed in an upper surface of the upper cap 25.

The guide groove 400 may be open upward and may be exposed through an upper surface of the hinge mounting portion 251. Further, a front end of the hinge plate 310 may be positioned above the guide groove 400, and the hinge pins 330 coupled to the hinge plate 310 may be inserted into the guide groove 400.

The hinge pins 330 may be provided as a pair and may be inserted into the guide groove 400. Further, the hinge pins 330 may move along the guide groove 400 in accordance with opening and closing of the door 21. In this case, the hinge pins 330 may maintain contact with the guide groove 400, thereby allowing a rotation center of the door 21 to move.

A bottom surface of the hinge mounting portion 251 in which the guide groove 400 is open may be formed at the same height as an upper surface of the cabinet 10 or may be formed to be lower by the predetermined height H1. Accordingly, a lower surface of the hinge plate 310 does not contact the hinge mounting portion 251 or an upper surface of the guide member 40.

Meanwhile, contact members 35 may be provided on the hinge pins 330. The contact members 35 may be configured as plate-shaped washers and may be formed of a metal material. Further, the contact members 35 may be formed with a pair of through-holes 351 through which the hinge pins 330 pass. In addition, the contact members 35 may be formed to have a size larger than a width of the upper surface of the guide member 40.

Further, in a state in which the hinge pins 330 are inserted into the guide groove 400, the contact members 35 may contact the upper surface of the guide member 40. Accordingly, during an opening and closing process of the door 21, it is possible to prevent local wear of the guide member 40 caused by collision between an upper end of the guide member 40 and the hinge pins 330 due to movement of the door 21. In addition, by the contact members 35, a gap between the lower surface of the hinge plate 310 and the guide member 40 may be minimized, thereby preventing upward and downward movement of the door 21.

Hereinafter, with reference to FIG. 8, a detailed structure of the guide member 40 and a movement state of the hinge pins 330 during opening and closing of the door 20 will be described in more detail with reference to the drawings.

A single guide groove 400 formed in the guide member 40 may form a movement path along which the pair of hinge pins 330 move while both hinge pins 330 are inserted therein. The guide groove 400 may be formed by continuously arranging a plurality of paths 406 extending in different directions. That is, the hinge pins 330 may move sequentially through the plurality of paths 406, such that the door 20 is opened and closed while a position of a rotation center C of the door 21 is changed. In other words, during an opening and closing process, the door 21 may rotate and move so as not to interfere with an adjacent wall, another refrigerator, or a home appliance.

For example, the guide groove 400 may be composed of five paths 406. The paths 406 may extend in different extension directions, and the five paths 406 may have a structure in which they are continuously connected. The plurality of paths 406 may be formed in various shapes, such as linear shapes, rounded shapes having different curvatures, or arc shapes having different center points, and at least one or more of these shapes may be combined with each other.

A movement path of the hinge pins 330 may be determined by a shape of the guide groove 400, and a position of the rotation center C of the door 21 may move according to a position of the hinge pins 330 being moved. That is, the rotation center C of the door 21 does not refer to a single fixed axis, but may be understood as a virtual rotation center that varies according to movement paths of the first hinge pin 331 and the second hinge pin 332.

For example, the guide groove 400 may be composed of a plurality of paths 406 defined by a plurality of arcs having different center points. That is, the guide groove 400 may be formed by continuously connecting a first path 401, a second path 402, a third path 403, a fourth path 404, and a fifth path 405. Centers C of the paths 406 may be located at different positions. In this case, the centers C of the paths 406 are virtual points that do not appear on the actual door 20 and may also be referred to as virtual centers.

The first path 401 may be formed at one end of the guide groove 400. The first path 401 may be formed such that the hinge pins 330 are positioned when the door 20 is in a closed state. That is, the first hinge pin 331 and the second hinge pin 332 may be positioned at opposite ends of the first path 401. An extension direction of the first path 401 may correspond to an arrangement of the first hinge pin 331 and the second hinge pin 332. Further, a length of the first path 401 may correspond to a distance between centers of the first hinge pin 331 and the second hinge pin 332.

Accordingly, the first path 401 may form a movement path along which the hinge pins 330 move when the door 21 starts to open. That is, when the hinge pins 330 start to move along the first path 401, the door 21 may be opened.

Further, a first center C1, which is a center of an arc forming the first path 401, may be a point at which a vertical line passing through a contact point between the first hinge pin 331 and the guide groove 400 intersects with a vertical line passing through a contact point between the second hinge pin 332 and the guide groove 400.

The first center C1 may be positioned in an edge region between a front surface and a side surface of the door 20 so as not to interfere with a wall surface on which the refrigerator is installed when opening of the door 20 starts. Further, the first center C1 may be positioned closest to a side surface of the door 20 among the centers C, that is, positioned at a leftmost position in an x-axis direction in FIG. 8.

The second path 402 may extend leftward and rearward from an end of the first path 401. A length of an arc of the second path 402 may be formed to be shorter than a length of an arc of the first path 401. Further, a second center C2, which is a center of an arc forming the second path 402, may be positioned further forward than the first center C1 in a y-axis direction in FIG. 8 and may be located at a position farther from a side surface of the door 20.

The third path 403 may extend leftward and rearward from an end of the second path 402. A length of an arc of the third path 403 may be formed to be shorter than a length of an arc of the second path 402. Further, a third center C3, which is a center of an arc forming the third path 403, may be positioned forward of the first center C1 in the y-axis direction in FIG. 8 and may be positioned further rearward than the second center C2. In addition, the third center C3 may be located at a position farther from a side surface of the door 21 than the second center C2.

The fourth path 404 may extend leftward and forward from an end of the third path 403. A length of an arc of the fourth path 404 may be formed to be longer than the lengths of the arcs of the second path 402 and the third path 403, and shorter than the length of the arc of the first path 401. Further, a fourth center C4, which is a center of an arc forming the fourth path 404, may be positioned forward of the first center C1 in the y-axis direction in FIG. 8 and may be positioned further rearward than the third center C3. In addition, the fourth center C4 may be located at a position farther from a side surface of the door 21 than the third center C3.

The fifth path 405 may form the other end of the guide groove 400. The fifth path 405 may be formed such that the hinge pins 330 are positioned when the door 20 is in a fully opened state. In this case, a length of the fifth path 405 may be formed to be shorter than a distance between centers of the first hinge pin 331 and the second hinge pin 332.

The fifth path 405 may extend leftward and forward from an end of the fourth path 404. Both the fifth path 405 and the first path 401 may extend in a forward direction, and the first path 401 may be formed to extend further forward than the fifth path 405.

A length of an arc of the fifth path 405 may be formed to be longer than the lengths of the arcs of the second path 402 and the third path 403, and shorter than the length of the arc of the first path 401. Further, a fifth center C5, which is a center of an arc forming the fifth path 405, may be positioned rearward of the first center C1 and may be positioned furthest rearward among the plurality of centers. In addition, the fifth center C5 may be located at a position farther from a side surface of the door 21 than the fourth center C4. That is, the first center C1 through the fifth center C5 may be sequentially positioned farther away from the side surface of the door 21. Accordingly, the guide groove 400 may allow movement of the hinge pins 330 to be performed more smoothly, thereby enabling smooth opening and closing rotational operation of the door 21.

As described above, the first hinge pin 331 and the second hinge pin 332 move along the paths 401 to 405 of the guide member 40 to rotate the door 21. Further, by allowing the door 21 to be opened and closed while a rotation center of the door 21 is changed, it is possible to prevent an end of the door 21 from protruding laterally from the cabinet 10 and contacting a wall surface adjacent to a side of the refrigerator 1 during an opening and closing process of the door 21. Accordingly, even when the refrigerator 1 is installed very close to an adjacent wall surface, rotational movement of the door 21 may be ensured without interference during opening and closing of the door 21.

Hereinafter, the hinge 31 will be described in more detail with reference to the drawings.

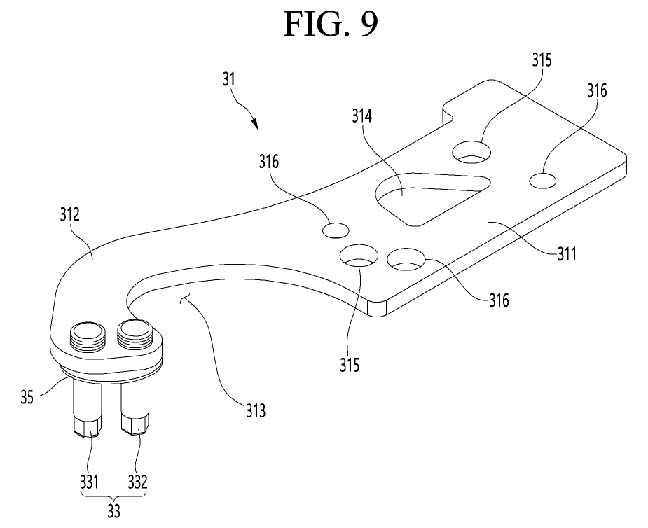

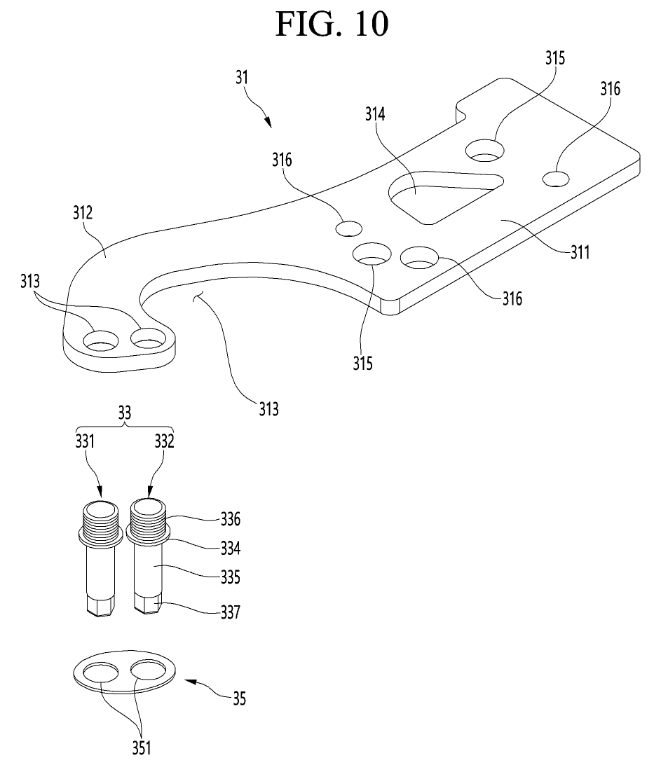

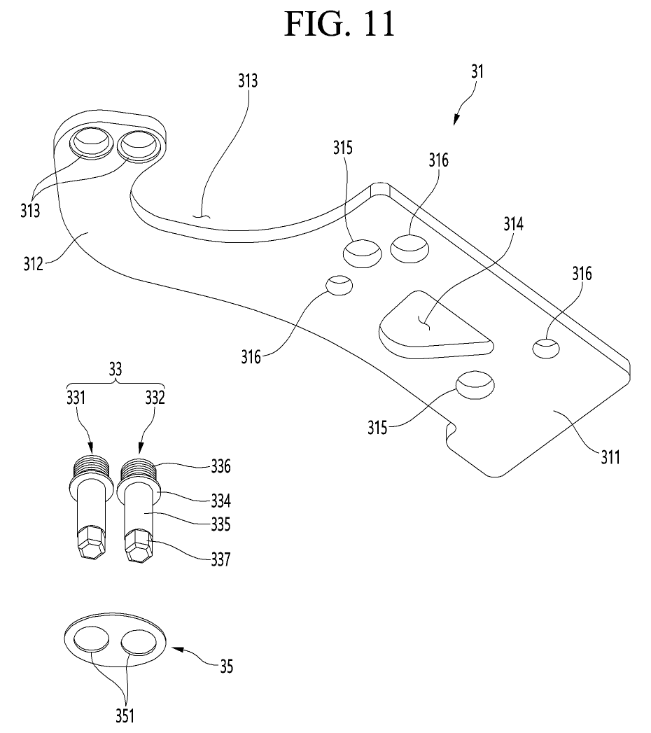

FIG. 9 is a perspective view of the hinge, and FIG. 10 is an exploded perspective view of the hinge as viewed from above, and FIG. 11 is an exploded perspective view of the hinge as viewed from below.

As illustrated, the hinge 31 may include a plate-shaped hinge plate 310 and hinge pins 330 mounted to the hinge plate 310.

The hinge plate 310 may be formed of a metal material and may have a plate shape having planar upper and lower surfaces. Further, the hinge plate 310 may include a mounting portion 311 mounted to the hinge coupling portion 16, and an extension portion 312 extending forward from the mounting portion 311 to the hinge mounting portion 251. The first hinge pin 331 and the second hinge pin 332 may be provided at an end of the extension portion 312.

The mounting portion 311 may be coupled to an upper surface of the cabinet 10 and may be disposed in the hinge coupling portion 16. Guide holes 315 and hinge fastening holes 316 may be formed on both left and right sides with respect to an extension line L2 passing through a center of the mounting portion 311 in a left–right direction.

The guide holes 315 may be formed through the mounting portion 311 so as to allow guide protrusions to be inserted therein. A plurality of guide holes 315 may be arranged in a front–rear direction and may be disposed on left and right sides with respect to the extension line L2. Further, the guide holes 315 may be arranged in front of and behind the center opening 314. For example, two guide holes 315 may be formed.

The hinge fastening holes 316 may be formed through the mounting portion 311 so as to allow fastening members 319 to be fastened therein. The hinge fastening holes 316 may be formed at positions corresponding to the cabinet fastening holes 162. Further, a plurality of hinge fastening holes 316 may be arranged in a front–rear direction and may be disposed on left and right sides with respect to the extension line L2. In addition, the hinge fastening holes 316 may be arranged in front of and behind the center opening 314. For example, three hinge fastening holes 316 may be formed, with two arranged at a front side and one arranged at a rear side.

The extension portion 312 may extend forward from a front end of the mounting portion 311 and may be formed to have a rounded shape with a predetermined curvature. Further, the extension portion 312 may have a width narrower than a left–right width of the mounting portion 311, and may form a recessed curved portion 318 recessed so as to accommodate an end of the hinge mounting portion 251 during an opening and closing process of the door 21.

The extension portion 312 may extend to the guide groove 400 located in the hinge mounting portion 251. Further, pin holes 313 to which the hinge pins 330 are mounted may be formed at an end of the extension portion 312. A pair of pin holes 313 may be formed, and the first hinge pin 331 and the second hinge pin 332 constituting the hinge pins 330 may be mounted to the respective pin holes 313. Further, threads may be formed on inner surfaces of the pin holes 313 so as to be fastened to coupling portions 336 of the hinge pins 330 in a threaded manner. Accordingly, the hinge pins 330 may be detachably mounted to the hinge plate 310. In order to form the pin holes 313, the end of the extension portion 312 may be formed to have a larger width than a middle portion of the extension portion 312.

Meanwhile, depending on a left–right arrangement position of the hinge 31, the hinge pins 330 may have a structure in which the hinge pins 330 are fastened from below the pin holes 313 and protrude downward, or a structure in which the hinge pins 330 are fastened from above the pin holes 313 and protrude upward. That is, the hinge pins 330 may be fastened from an upper side or a lower side of the hinge plate 310 depending on a mounting orientation of the hinge 31.

The first hinge pin 331 and the second hinge pin 332 may be spaced apart from each other in a front–rear direction. Further, the first hinge pin 331 and the second hinge pin 332 may also be spaced apart from each other in a left–right direction.

In this case, the first hinge pin 331 may be positioned further forward than the second hinge pin 332. Further, the first hinge pin 331 may be positioned further laterally outward than the second hinge pin 332 with respect to a center of the door 21. Accordingly, height adjustment operation of the first hinge pin 331 may be facilitated.

The first hinge pin 331 and the second hinge pin 332 may be fastened to the hinge plate 310. Further, the first hinge pin 331 and the second hinge pin 332 may extend vertically upward with respect to an upper surface of the hinge plate 310. Accordingly, the first hinge pin 331 and the second hinge pin 332 may be respectively inserted into the guide grooves 400 provided in the door 21.

The first hinge pin 331 and the second hinge pin 332 may be formed to have identical shapes and may be respectively mounted to the pin holes 313. Describing the hinge pin 330 in more detail with reference to the second hinge pin 332, the hinge pin 330 may include an insertion portion 335, a protruding portion 334, and a coupling portion 336. The insertion portion 335 may form a lower portion of the hinge pin 330 and may extend so as to be inserted into the guide groove 400. A diameter of the insertion portion 335 may be formed to correspond to a width of the guide groove 400. Accordingly, in a state in which the door 20 is mounted, the hinge pin 330 may contact an inner surface of the guide groove 400.

Further, the protruding portion 334 protruding outward may be formed at an upper end of the insertion portion 335. The protruding portion 334 may contact the upper surface of the hinge plate 310 and may contact a periphery of the pin hole 313. The protruding portion 334 may be formed to have an outer diameter larger than an outer diameter of the insertion portion 335. Further, a lower surface of the protruding portion 334 may contact a lower surface of the hinge plate 310, such that the hinge pin 330 may be mounted at a predetermined height.

The coupling portion 336 may extend upward from the upper end of the insertion portion 335. Threads corresponding to threads formed on an inner surface of the pin hole 313 may be formed on an outer surface of the coupling portion 336. Accordingly, the hinge pin 330 may be threadedly coupled to the pin hole 313.

Meanwhile, in order to allow threaded coupling of the hinge pin 33, an operation portion 337 may be formed at a lower end of the insertion portion 335. An outer surface of the operation portion 337 may be formed in a polygonal shape, such that the hinge pin 330 may be easily rotated using a tool. For example, the operation portion 337 may be formed in a hexagonal nut shape, such that the hinge pin 330 may be rotated using a spanner or a dedicated tool to allow the coupling portion 336 and the pin hole 313 to be coupled to each other. Further, the operation portion 337 may be formed so as not to protrude further than an outer surface of the insertion portion 335, thereby preventing contact with an inner surface of the guide groove 400 when the insertion portion 335 is inserted into the guide groove 400.

Further, the hinge pin 330 may be threadedly coupled to the pin hole 313 from an upper side of the pin hole 313 such that the coupling portion 336 protrudes upward from the pin hole 313. That is, depending on an arrangement of the hinge 31, the coupling portion 336 may be coupled to the pin hole 313 such that the hinge pin 330 protrudes upward or downward.

Meanwhile, the hinge 31 having the above-described structure may be mounted in different orientations depending on a mounting position. That is, a single hinge 31 may be mounted to the hinge coupling portions 16 on the left and right sides in a first use state, or in a second use state in which the hinge 31 is inverted.

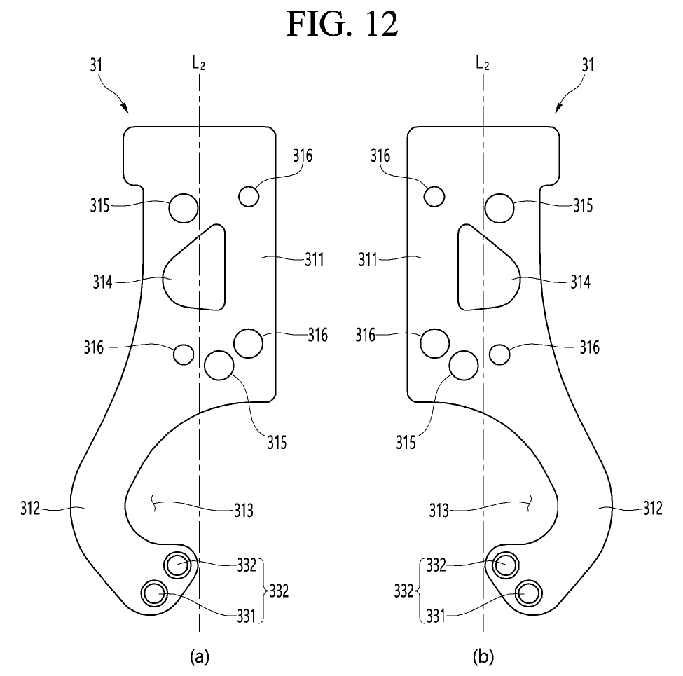

FIG. 12 is a view illustrating a convertible use state of the hinge.

As illustrated in FIG. 3, in a first use state in which the hinge 31 is mounted to connect the cabinet 10 and the door 21 at a right-side end, the hinge 31 may be arranged as illustrated in FIG. 12(a).

In this case, the extension portion 312 may be formed to be curved from left to right, and the recessed curved portion 318 may be formed to open toward the right side. Further, in this arrangement, the hinge pins 330 may be coupled to the pin holes 313 and may have a structure protruding downward.

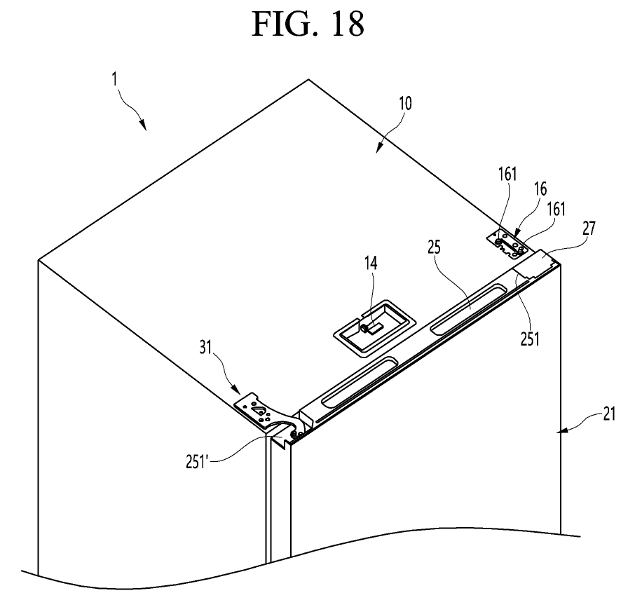

On the other hand, as illustrated in FIG. 18, in a second use state in which the hinge 31 is mounted to connect the cabinet 10 and the door 21 at a left-side end, the hinge 31 may be arranged as illustrated in FIG. 12(b).

In this case, the hinge plate 310 may be arranged by inverting the same hinge plate 310 used in FIG. 12(a) in an upward and downward direction. That is, an upper surface of the hinge plate 310 in FIG. 12(a) may face downward in FIG. 12(b).

When the hinge plate 310 is in the inverted state, the extension portion 312 may be formed to be curved from right to left, and the recessed curved portion 318 may be formed to open toward the left side. Further, in this arrangement, the hinge pins 330 may be coupled to the pin holes 313 and may have a structure protruding downward.

The hinge 31 of FIG. 12(a) and the hinge 31 of FIG. 12(b) may have shapes that are symmetrical to each other. Further, in FIGS. 12(a) and 12(b), the center opening 314, the guide holes 315, and the hinge fastening holes 316 formed in the mounting portion 311 may also have mutually symmetrical arrangement structures.

Hereinafter, states of the hinge 31 and the door 21 according to opening and closing of the door 21 of the refrigerator 1 having the above-described structure will be described in more detail with reference to the drawings, and with reference to positions of the hinge pins 330 in the plurality of paths 406 constituting the guide groove 400 illustrated in FIG. 8.

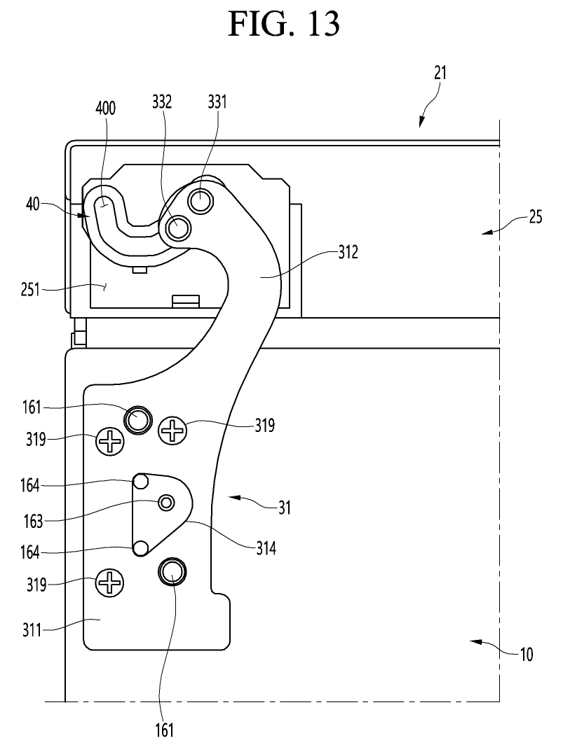

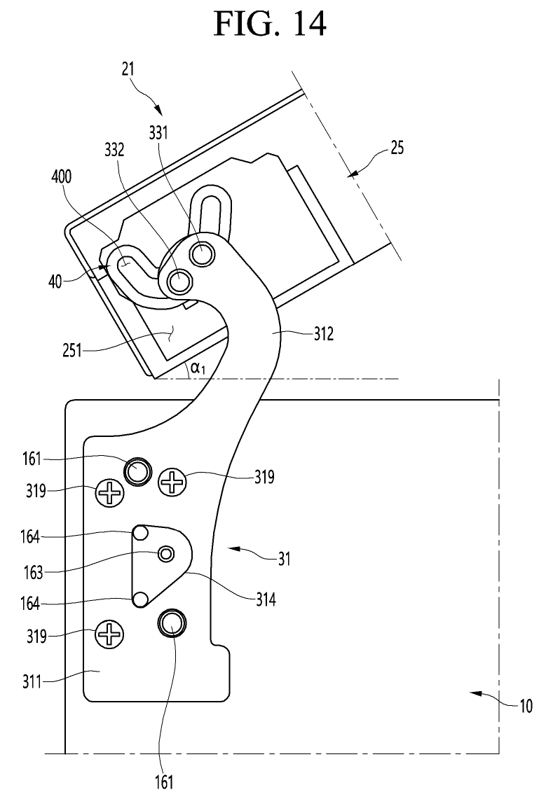

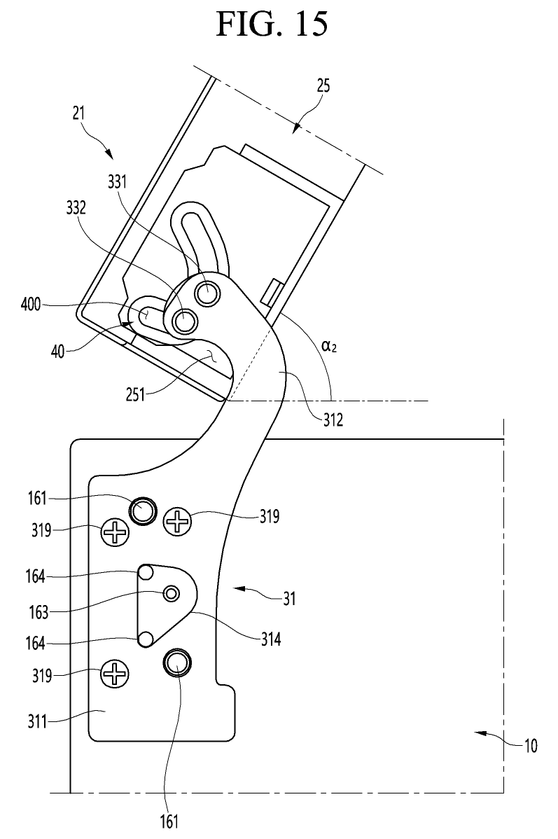

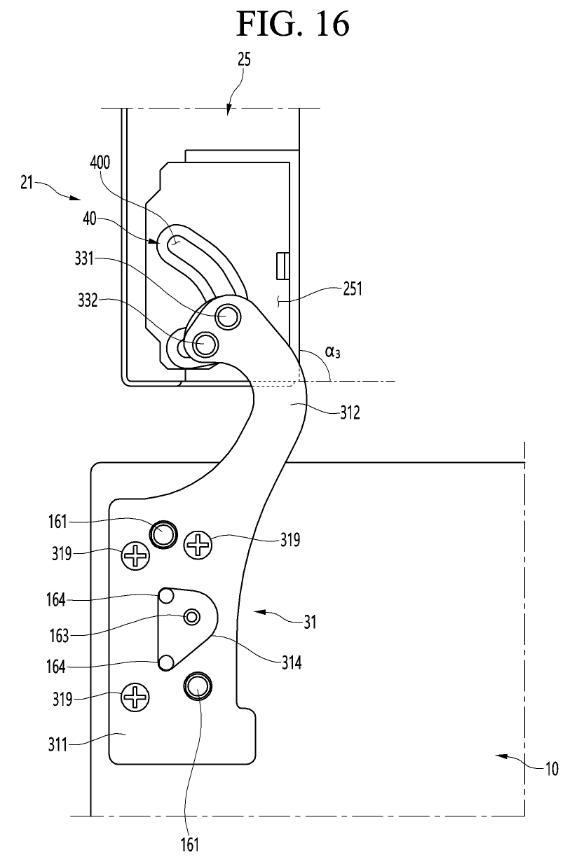

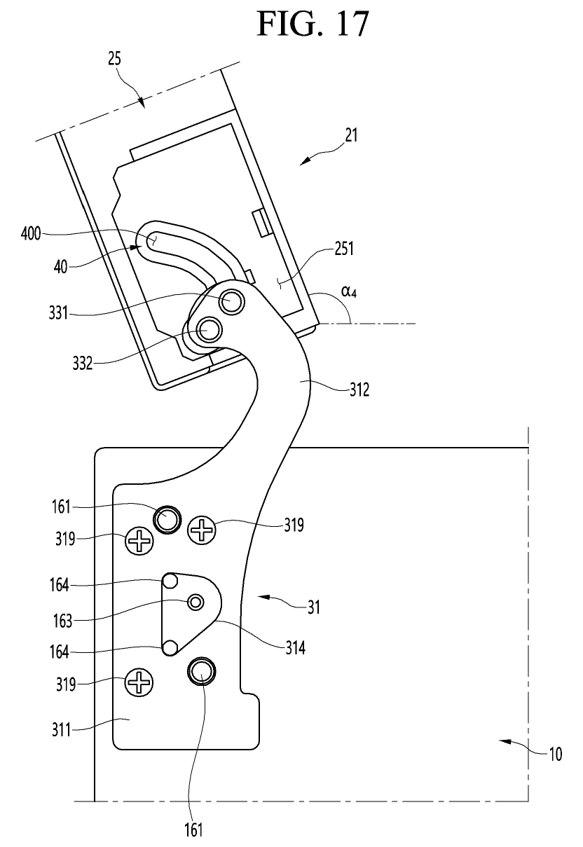

FIG. 13 is a view illustrating states of the hinge and the door when the door is closed, and FIG. 14 is a view illustrating states of the hinge and the door when the door is opened at a first predetermined angle, and FIG. 15 is a view illustrating states of the hinge and the door when the door is opened at a second predetermined angle, and FIG. 16 is a view illustrating states of the hinge and the door when the door is opened at a third predetermined angle, and FIG. 17 is a view illustrating states of the hinge and the door when the door is fully opened.

As illustrated in FIG. 13, when the door 21 is in a closed state, the first hinge pin 331 and the second hinge pin 332 may be positioned at opposite ends of the first path 401. In particular, the second hinge pin 332 may be disposed at an intersection point between arcs forming the first path 401 and the second path 402. Accordingly, at a moment when opening of the door 20 starts, the second hinge pin 332 may move into the second path 402.

When a user performs an opening operation of the door 20, the door 20 may start to open while undergoing an instantaneous movement toward the front and the right along a direction of the first path 401.

At the moment when opening of the door 20 starts, the first hinge pin 331 may move along the first path 401, and the second hinge pin 332 may enter the second path 402.

Further, when the door 21 is further rotated, as illustrated in FIG. 14, the door 21 may be further opened such that a first predetermined angle α1 is formed between a front surface of the cabinet 10 and a rear surface of the door 21. For example, the first predetermined angle α1 may be approximately 30°. In this case, the first hinge pin 331 may be moved to the second path 402, and the second hinge pin 332 may be moved to the fourth path 404. That is, the third path 403 may be positioned between the first hinge pin 331 and the second hinge pin 332.

In this state, an edge of the door 21 and an adjacent wall surface may be at a closest distance to each other, and the door 21 may rotate without colliding with the wall surface. Further, the hinge pins 330 may smoothly move along the guide groove 400, and the first hinge pin 331 and the second hinge pin 332 may move along different paths, namely the second path 402 and the third path 403, respectively, such that the door 21 rotates without twisting or occurrence of slip.

Further, when the door 21 is further rotated, as illustrated in FIG. 15, the door 21 may be further opened such that a second predetermined angle α2 is formed between the front surface of the cabinet 10 and the rear surface of the door 21. The second predetermined angle α2 may be approximately 50°. In this case, the first hinge pin 331 may move to the third path 403, and the second hinge pin 332 may move while passing through the fourth path 404.

Further, when the door 21 is further rotated, as illustrated in FIG. 16, the door 21 may be opened such that a third predetermined angle α3 is formed between the front surface of the cabinet 10 and the rear surface of the door 21. For example, the third predetermined angle α3 may be approximately 90°. In this case, the first hinge pin 331 may move to the fourth path 404, and the second hinge pin 332 may move to the fifth path 405.

In this state, a front surface 201 of the door 21 and an adjacent wall surface may be spaced apart from each other, and the door 21 does not collide with the wall surface. Further, the hinge pins 330 may smoothly move along the guide groove 400, and the first hinge pin 331 and the second hinge pin 332 may move along different paths, namely the fourth path 404 and the fifth path 405, respectively, such that the door 20 rotates without twisting or occurrence of slip.

Further, when the door 21 is further rotated, as illustrated in FIG. 17, the door 21 may be opened to a maximum angle corresponding to a fourth predetermined angle α4. For example, the fourth predetermined angle α4 may be approximately 120°. When the door 21 is opened by the fourth predetermined angle α4, the first hinge pin 331 may move to the fourth path 404, and the second hinge pin 332 may move to an end of the fifth path 405.

As described above, during an opening and closing process of the door 20, the hinge pins 330 move along the paths of the guide groove 400, and the door 21 moves while a rotation center C is changed, such that the door 21 can be opened without colliding with an adjacent wall surface.

Further, while opening of the door 21 proceeds, the first hinge pin 331 may sequentially move from the first path 401 to the fourth path 404, and the second hinge pin 332 may sequentially move from the second path 402 to the fifth path 405.

A closing process of the door 21 may be performed in a reverse order of the operations of the above-described embodiment.

Meanwhile, an opening and closing direction of the door 21 may be selected or changed according to an installation environment and a user’s preference. Hereinafter, this will be described in more detail with reference to the drawings.

FIG. 18 is a partial perspective view illustrating a hinge arrangement in a state in which an opening and closing direction of the door is changed.

As illustrated, depending on an installation environment of the refrigerator 1 and a user’s preference, the door 21 may be opened and closed while rotating about a left-side end.

For this purpose, the hinge 31 may be mounted to the hinge coupling portion 16 on a left side of the cabinet 10. Further, the hinge pins 330 may be inserted and mounted to the hinge mounting portion 251′ formed at an upper left side of the door 21.

In this case, the hinge 31 is not a separately provided hinge. Instead, the hinge pins 330 may be separated from the hinge 31 of FIG. 12(a), the hinge plate 310 may then be inverted, and the hinge pins 330 may be coupled again to the hinge plate 310 such that the hinge pins 330 face downward.

That is, by using a single hinge 31, the door 21 may be converted from a configuration in which the door 21 rotates about a right-side end as illustrated in FIG. 3 to a configuration in which the door 21 rotates about a left-side end as illustrated in FIG. 18.

Further, a mounting portion cover 27 may be provided on the hinge mounting portion 251 at a right side of the upper cap 25 where the hinge 31 is not mounted, thereby covering the hinge mounting portion 251 on the right side.

The present invention may have various other embodiments in addition to the above-described embodiment. Other embodiments of the present invention differ only in a structure of the door and an arrangement of the hinge, and other structures are the same as those of the above-described embodiment. Accordingly, hereinafter, only configurations that differ from the above-described embodiment will be described in detail, and configurations identical to those of the above-described embodiment will be denoted by the same reference numerals and detailed descriptions thereof will be omitted to avoid redundant descriptions. Further, reference numerals that are not described may be understood based on the descriptions of the above-described embodiment.

Hereinafter, a second embodiment of the present invention will be described in more detail with reference to the drawings.

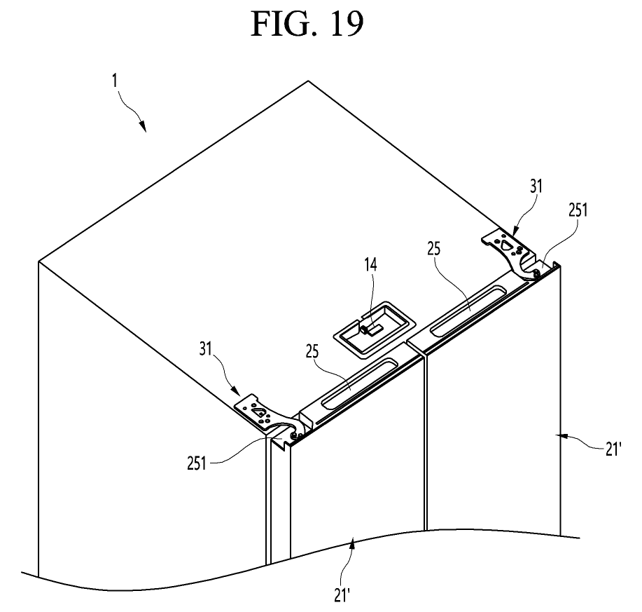

FIG. 19 is a partial perspective view illustrating a hinge arrangement of a refrigerator according to a second embodiment of the present invention.

As illustrated, a refrigerator 1 according to a second embodiment of the present invention may include a cabinet 10 in which a storage space is formed, and a pair of doors 21 configured to open and close the storage space. In this case, the pair of doors 21 may be upper doors.

The pair of doors 21 may be opened and closed by rotating about left-side ends and right-side ends thereof, respectively. For this purpose, hinges 31 may be provided at upper ends of the respective doors 21.

In this case, hinge plates 310 of the hinges 31 may have the same structure, and when one of the hinge plates 310 is inverted, it may have the same shape as the other hinge plate 310. That is, a single hinge plate 310 having a unitary shape may be used for the doors 21 on both left and right sides in the first use state and the second use state illustrated in FIG. 12.

Further, hinge pins 330 may be coupled to the hinge plates 310, and the hinge pins 330 may be mounted to hinge mounting portions 251 of upper caps 25 forming upper surfaces of the doors 21 on both left and right sides. In this case, the pair of hinge pins 330 may be inserted into the guide groove 400 of the guide member 40 and may move along a single guide groove 400 according to opening and closing of the door 21.

A refrigerator according to an embodiment of the present invention has the following advantages.

According to the embodiment, a hinge is composed of a hinge plate and hinge pins, and the hinge plate is formed in a planar shape and can be mounted on both left and right sides of the door by being inverted in an upward and downward direction.

Accordingly, there is an advantage in that a hinge having an identical structure can be mounted to either a left-side hinge mounting portion or a right-side hinge mounting portion.

In particular, since a pair of hinge pins is detachably coupled to the hinge plate, the hinge plate can be arranged in a first state or an inverted second state depending on a mounting position of the hinge, and the hinge pins can be mounted to the hinge plate.

Accordingly, there is an advantage in that the hinge can be applied to hinge mounting portions on both sides by using a single hinge structure without the need to manufacture separate hinges.

In particular, in a refrigerator in which a door opening and closing direction can be changed, even when only one hinge is provided, the hinge can be selectively mounted to hinge mounting portions on both sides, thereby reducing manufacturing costs and improving productivity.

Further, even when a pair of doors is arranged side by side, hinges having an identical structure can be mounted to the left door and the right door, respectively, and a hinge mounted to one door and a hinge mounted to the other door have an arrangement structure inverted in the upward and downward direction.

Accordingly, there is an advantage in that the hinge can be mounted to both doors by using the same hinge plate structure.

What is claimed is:

1. A refrigerator comprising:
a cabinet forming a storage space;
a door configured to open and close the storage space;
a hinge including a hinge plate mounted to the cabinet, and a first hinge pin and a second hinge pin protruding from the hinge plate and connected to a hinge mounting portion recessed in the door; and
a guide groove provided in the hinge mounting portion, into which both the first hinge pin and the second hinge pin are inserted and which guides movement of the first hinge pin and the second hinge pin during rotation of the door,
wherein the hinge mounting portion is one of hinge mounting portions respectively provided at left and right sides of an upper surface of the door, and
wherein the hinge is mounted to one of the hinge mounting portions on the left and right sides according to an opening and closing direction of the door.

2. The refrigerator according to claim 1,
wherein the hinge plate has planar upper and lower surfaces, and
wherein, when the hinge plate is mounted to one hinge mounting portion on one of the left and right sides, the hinge plate is mounted in an inverted state in an upward and downward direction relative to a hinge plate mounted to the other hinge mounting portion.

3. The refrigerator according to claim 2,
wherein the first hinge pin and the second hinge pin are detachably mounted to the hinge plate.

4. The refrigerator according to claim 3,
wherein the hinge plate is formed with a pair of pin holes into which the first hinge pin and the second hinge pin are inserted, and
wherein the first hinge pin and the second hinge pin are threadedly coupled to the pin holes.

5. The refrigerator according to claim 4,
wherein each of the first hinge pin and the second hinge pin includes:
a coupling portion having threads formed on an outer surface thereof and coupled to the pin hole;
an insertion portion extending downward from the hinge plate and inserted into the guide groove; and
a protruding portion protruding outward between the coupling portion and the insertion portion and contacting a lower surface of the hinge plate.

6. The refrigerator according to claim 5,
wherein a lower end of the insertion portion is formed in a polygonal shape, and
wherein an operation portion configured to rotate the first hinge pin or the second hinge pin so that the coupling portion and the pin hole are threadedly coupled to each other is formed at the lower end.

7. The refrigerator according to claim 1,
wherein the hinge plate includes:
a mounting portion coupled to and fixed to hinge coupling portions provided at left and right sides of an upper surface of the cabinet; and
an extension portion extending forward from a front end of the mounting portion and having the first hinge pin and the second hinge pin coupled to an extended end thereof.

8. The refrigerator according to claim 7,
wherein an inner surface of the extension portion opens toward a center of an upper end of the door and forms a recessed curved portion having a predetermined curvature.

9. The refrigerator according to claim 7,
wherein the hinge coupling portions include a plurality of guide protrusions protruding upward from an upper surface of the cabinet,
wherein the mounting portion is formed with guide holes through which the guide protrusions are inserted at positions corresponding to the guide protrusions, and
wherein the guide holes are disposed on left and right sides with respect to an extension line passing through a center of the mounting portion in a left–right direction.

10. The refrigerator according to claim 9,
wherein the guide holes are spaced apart from each other in a front–rear direction.

11. The refrigerator according to claim 10,
wherein a pair of sub guide protrusions protruding upward between the plurality of guide protrusions are formed on the hinge coupling portion,
wherein a center opening penetrating the mounting portion is formed in the mounting portion, and
wherein the pair of sub guide protrusions contact an inner surface of the center opening to guide mounting of the hinge.

12. The refrigerator according to claim 9,
wherein a plurality of hinge fastening holes through which fastening members pass are formed in the mounting portion on left and right sides with respect to the extension line passing through the center of the mounting portion in the left–right direction, and
wherein cabinet fastening holes to which the fastening members are fastened are formed in the hinge coupling portions corresponding to the hinge fastening holes.

13. The refrigerator according to claim 12,
wherein the cabinet fastening holes are spaced apart from each other in a front–rear direction.

14. The refrigerator according to claim 1,
further comprising an upper cap forming an upper surface of the door,
wherein the hinge mounting portion is recessed at each of left and right ends of the upper cap.

15. The refrigerator according to claim 14,
wherein the hinge is coupled to one of the hinge mounting portions on the left and right sides, and
wherein a mounting portion cover covering the hinge mounting portion is provided on the other hinge mounting portion.

16. The refrigerator according to claim 14,
wherein guide members each having the guide groove formed therein are provided at both hinge mounting portions, and
wherein the guide members are formed symmetrically with respect to a center of the door.

17. The refrigerator according to claim 16,
further comprising a contact member formed in a plate shape and having a pair of through-holes through which the first hinge pin and the second hinge pin pass,
wherein the guide groove and an upper end of the guide member are exposed through an upper surface of the hinge mounting portion, and
wherein the contact member contacts the upper end of the guide member.

18. The refrigerator according to claim 17,
wherein the contact member is formed to have a width greater than a width of the guide member.

19. The refrigerator according to claim 17,
wherein an upper surface of a hinge coupling portion on the cabinet protrudes upward by a predetermined height relative to a bottom surface of the hinge mounting portion, and
wherein the contact member is disposed between an upper surface of the guide member and a lower surface of the hinge plate.

20. The refrigerator according to claim 1,
wherein the guide groove is formed by continuously connecting a plurality of paths extending in different directions, and
wherein, during opening and closing of the door, the first hinge pin and the second hinge pin are configured to move along different paths among the plurality of paths.
